(19) United States
(12) Patent Application Publication
(10) Pub. No.: US 2008/0156941 A1
(43) Pub. Date: Jul. 3, 2008

(54) METHODS AND APPARATUS FOR AIRCRAFT STRUCTURAL LENGTH OF SERVICE ENHANCEMENT

(76) Inventors: Ko-Wei Liu, Seal Beach, CA (US); Hugo Guzman, Long Beach, CA (US); Hasan I. Ramlaoui, Lake Elsinore, CA (US)

Correspondence Address: JOHN S. BEULICK (24691);ARMSTRONG TEASDALE LLP, ONE METROPOLITAN SQUARE, SUITE 2600, ST. LOUIS, MO, 63102-2740, US

(21) Appl. No.: 11/618,187

(22) Filed: Dec. 29, 2006

(51) Int. Cl. B64C 3/00; C22F 1/00

(52) U.S. Cl. 244/35 R; 148/559; 148/508

(57) ABSTRACT

A method for reworking an aircraft wing, attached to an aircraft fuselage, to reduce a propensity for advanced dynamic changes is described. The reworking method includes verifying components of the aircraft wing are in a condition acceptable for reworking, removing at least one existing fastener from the wing, reworking the at least one fastener hole using a coldworking process, and installing an oversized fastener into the at least one reworked fastener hole.

### BACKGROUND OF THE DISCLOSURE

Embodiments of the disclosure relate generally to aircraft structural component advanced dynamic changes, and more specifically, to methods and apparatus for extending the length of service of aircraft structural components such as wings.

In some aircraft, structural components may experience advanced dynamic changes at a date earlier than expected. Advanced dynamic changes may result in operating restrictions, and/or the grounding of the aircraft. In different aircraft, the wing components that suffer advanced dynamic changes may vary, based on aircraft configuration. For example, in the C-130 aircraft, the center wing box (CWB) is experiencing widespread advanced dynamic changes at an earlier date than expected resulting in operating restrictions and grounding. Grounding or retiring of the individual aircraft due to advanced dynamic changes may be overcome when the wing is removed and refurbished or removed and replaced.

Currently there are four methods to address the problem described above, specifically, advanced dynamic changes at the center wing box. The first method is to repair the CWB. However, this method may be a short term fix and includes associated high maintenance and inspection costs for the remaining life of the aircraft. The second method is to refurbish the CWB. This method may require removal of the CWB and replacing the lower wing skin and spars. This method does not provide a full length of service extension and requires continued inspection of the upper part of the CWB. While this method is more costly than the repair method, it may extend the length of service of the CWB.

A third method for addressing advanced dynamic changes at the center wing box is to replace the center wing box. As can be easily understood, replacing the CWB is very costly and time consuming as this method requires removal of the CWB and installation of a new CWB. The fourth method for addressing advanced dynamic changes at a CWB is to retire the aircraft and replace it with a new aircraft, which is the costliest solution.

What is needed is a fifth method that significantly reduces out of service time while significantly extending length of service of the CWB at a fraction of the costs of replacing the CWB.

### BRIEF DESCRIPTION OF THE DISCLOSURE

In one aspect, a method for reworking an aircraft wing, attached to an aircraft fuselage is provided. The reworking reduces the propensity for advanced dynamic changes and includes verifying components of the aircraft wing are in a condition acceptable for reworking, removing at least one existing fastener from the wing, reworking the at least one fastener hole using a coldworking process, and installing an oversized fastener into the reworked at least one fastener hole.

In another aspect, a method for processing an aircraft structure is provided that includes removing at least one existing fastener from the structure, inducing a compressive field around at least one fastener hole corresponding with the removed fastener using a coldworking process, and installing a fastener into each coldworked fastener hole.

In still another aspect, a method for reworking a C-130 aircraft wing while attached to an aircraft fuselage to prolong the onset of advanced dynamic changes is provided. The method includes verifying components of the C-130 aircraft wing are in a condition acceptable for reworking, removing at least one existing fastener from the C-130 aircraft wing, reworking the at least one fastener hole using a coldworking process, and installing an oversized fastener into the at least one reworked fastener hole.

### BRIEF DESCRIPTION OF THE DRAWINGS

FIG. 1 is a flow chart illustrating an aircraft wing length of service enhancement process.

FIG. 2 is an illustration of possible advanced dynamic changes in an aircraft structural component.

FIG. 3 is an illustration of a fastener hole coldworking process.

### DETAILED DESCRIPTION OF THE DISCLOSURE

Described herein is a method for enhancing the length of service of aircraft structural components, for example, but not limited to, a wing box, empennage, or fuselage section without limitation, without removing it from the aircraft. This method, which provides an alternative solution to the methods for addressing advanced dynamic changes described above, may extend the length of service of the aircraft wing box structure without removal of the wing from the aircraft fuselage. This method also reduces the down time of the aircraft by more than two months, as compared to the repair, refurbishment, and replacement methods described above. Further, the described method also reduces the cost of extending the length of service of the CWB by more than half as it compares to refurbishment or replacement. This refurbishment method is accomplished at about 20 percent of the cost of a new CWB.

With regard to aircraft, this method is also applicable to other structural areas of the aircraft, thereby extending the length of service of the aircraft. By increasing the structural length of service, other improvements may become cost effective and be introduced into the C-130, including, but not limited to, avionics and performance upgrades.

In one embodiment, an apparatus associated with the described method includes a structural enhancement to the center wing box (CWB) that is performed prior to the onset of widespread advanced dynamic changes. With regard to the CWB, the structural enhancement does not require removal of the CWB. In the CWB embodiment, the method for implementing the structural enhancement includes inspection of the CWB to determine the extent of corrosion or advanced dynamic changes. If the results of the inspection indicate that enhancement of the CWB is feasible, then the outer wing boxes and engines are removed and the fastener holes on both the upper and lower part of the CWB are reworked. Local rework is performed to improve length of service, and the rainbow and corner fittings of the CWB may be replaced as an option.

“Dynamic changes,” as the term is used in the appropriate context throughout this disclosure, refers to the difference between one or more measured characteristics of a structure under inspection (and potentially effected by repeated exposure to factor(s) including, but not limited to, thermal load(s), structural load(s), oxidation, lightning, or electrical arcing) with expected values for the same characteristics of an analogous structure unaffected by repeated exposure to those factors. Advanced dynamic changes is a highly developed state of dynamic changes.

The coldworking and local rework steps may be applied to either a refurbished or new wing, and this approach is different from other length of service enhancement approaches because it is pre-emptive (i.e., performed prior to onset of advanced dynamic changes), it does not require removal of CWB, and it enhances both upper and lower sides of the wing.

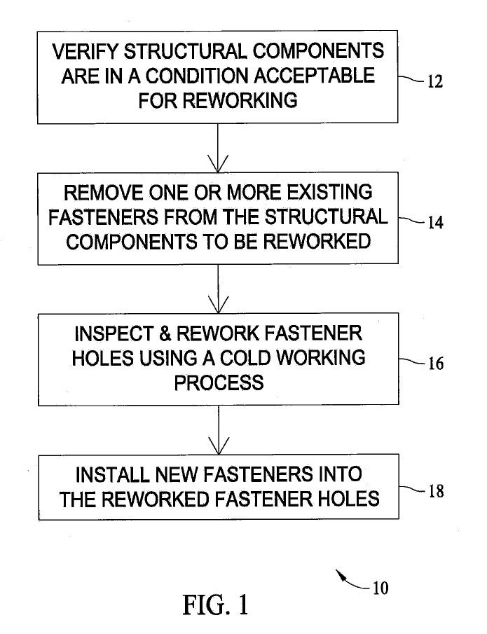

FIG. 1 is a flowchart 10 illustrating a method for reworking an aircraft wing that is attached to an aircraft fuselage. Reworking a wing with such a method reduces a propensity for advanced dynamic changes. One or more inspection processes are utilized to verify 12 components of the aircraft wing are in a condition acceptable for reworking. If the wing is in an acceptable condition for reworking, one or more existing fasteners are removed 14 from the wing. In various embodiments, only a subset of the fasteners are removed at any one time, so that the components held together by the fasteners do not move with respect to one another.

Once one or more fasteners are removed, the fastener holes are inspected and then reworked 16 using a coldworking process, and new fasteners are installed 18 into the reworked holes. Such fasteners may be different in size as compared to the original fasteners, based on the hole size after the coldworking process. One example of such a fastener is an interference fit fastener. Post coldworking, the hole may be reamed to accommodate an interference pin fastener, typically, but without, limitation, a pin. Countersinks, if needed, may have to be reworked as well prior to pin installation.

The above described inspection processes include one or more non-destructive inspection techniques (NDI) and a general visual inspection of, for example, the entire center wing box, before starting any rework to verify the CWB is in acceptable condition to rework. Examples of non-destructive inspection techniques include, for example, eddy current inspection of fastener holes and their surrounding areas, x-ray of holes and surrounding areas, and an ultrasonic inspection using a mobile automatic scanner, to name a few.

With respect to the mobile automatic scanner, an aircraft structural component is sample inspected using an array inspection technique provided by the mobile automatic scanner to identify, for example, inconsistencies and advanced dynamic changes, in the structural components being considered for repair. For example, inspection of a C-130 center wing box includes an inspection of the aircraft skin to stringer interface and the aircraft skin to spar cap interface with the mobile automatic scanner. The mobile automatic scanner is configured for aerospace specific applications to inspect for advanced dynamic changes over large areas of the structural components. Inspection with the mobile automatic scanner may be coupled with a close visual inspection of the center wing box to determine the general condition of the center wing box.

“Inconsistencies,” as the term is used in the appropriate context throughout this disclosure, refers to the difference between one or more measured characteristics of a structure under inspection(and potentially effected by exposure to factor(s) including, but not limited to, thermal load(s), structural load(s), oxidation, lightning, or electrical arcing) with expected values for the same characteristics of an analogous structure unaffected by exposure to those factors.

A method for refurbishing aircraft structural components includes removing at least a portion of the existing fasteners, inspecting the fastener holes, coldworking the fastener holes, reaming the holes, and installation of oversized interference fit pins.

More particularly, the fasteners may be removed in phases so the aircraft structural components do not move with respect to one another, causing hole misalignment. With respect to the coldworking of fastener holes after removal of the original fasteners, each individual hole may be cleaned and/or reamed for inspection, and fastener hole eddy current inspection is then performed. After inspection, the fastener hole may be reamed to a pre-coldwork diameter. The fastener hole is then coldworked, which is a cold expansion process, and an oversized interference fit pin is installed.

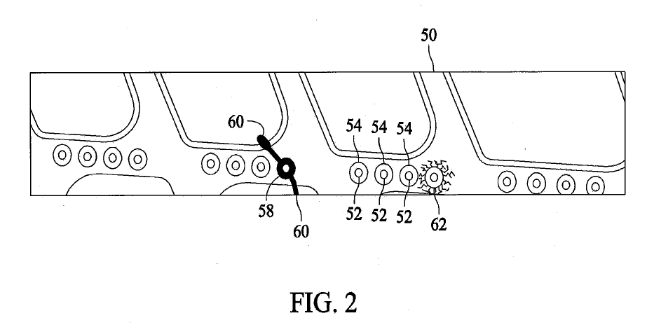

FIG. 2 is an illustration of a portion of an aircraft structural component 50 which includes a number of fasteners 52 inserted into corresponding fastener holes 54. Particularly, and as a result of, for example an ultrasonic scan, fastener hole 58 is noted as having one or more advanced dynamic changes 60 extending therefrom. The scan of fastener hole 62, may in addition indicate, for example, inconsistencies.

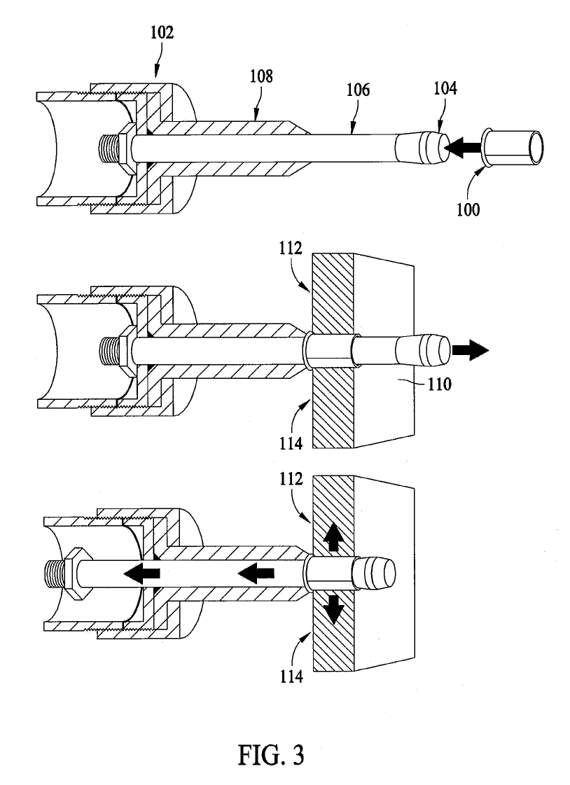

Once these fastener holes, for example, fastener holes 58 and 62 have been prepared for coldworking, a coldworking expansion process for the fastener hole is performed as illustrated by FIG. 3. Coldworking, sometimes referred to as cold expansion, of a fastener hole introduces beneficial compressive residual stress around the fastener hole which improves length of service. Referring specifically to FIG. 3, a split sleeve 100 is fit onto a tool 102 that includes a mandrel 104, shaft 106, and a nosecap 108. The mandrel 104 and a portion of shaft 106 are inserted through the hole 110 that is being coldworked. As the shaft 106 is inserted, split sleeve 100 engages nosecap 108, which forces split sleeve 100 into hole 100. As mandrel 104 is retracted from hole 110, nosecap 108 is still engaged with split sleeve 100. Mandrel 104 causes split sleeve 100 to expand, and this expansion is then imparted into the aircraft structure 112 and 114 that surrounds hole 1 10. The effect of removing the tightly fitting mandrel 104 through the sleeve 100 results in the above described beneficial compressive residual stress around the fastener hole 110 which improves length of service of the structure.

More generally, the process illustrated by FIG. 3 includes a method for processing an aircraft structure. The method includes removing existing fasteners from the structure, increasing fatigue strength of the structure around the fastener holes using a coldworking process, and installing a fastener into each reworked fastener hole.

These methods address widespread advanced dynamic change issues, and are applicable, in one example, to C-130 center wing box fabricated from 7075-T73 aluminum material and center wing boxes without corrosion conditions at the mating surfaces.

In the case of the C-130 center wing box, it has been determined that implementation of the above described method may add 25,000 equivalent baseline hours (EBH) (advanced dynamic change free service life from in service inspection findings). The above method can be implemented up to about 38,000 EBH when aircraft is subject to operational restrictions. Other selective local rework of other advanced dynamic change areas away from fastener holes is also contemplated.

A result of the above described methods include at least an aircraft wing attached to an aircraft fuselage that includes at least one fastener hole reworked using a coldworking process with an oversized fastener installed.

While embodiments of the disclosure have been described in terms of various specific embodiments, those skilled in the art will recognize that the embodiments of the disclsoure can be practiced with modification within the spirit and scope of the claims.

What is claimed is:

1. A method for reworking an aircraft wing, attached to an aircraft fuselage, to reduce a propensity for advanced dynamic changes, said method comprising:
verifying components of the aircraft wing are in a condition acceptable for reworking;
removing at least one existing fastener from the wing;
reworking the at least one fastener hole using a coldworking process; and
installing an oversized fastener into the reworked at least one fastener hole.

2. A method according to claim 1 wherein verifying components of the aircraft wing are in a condition acceptable for reworking comprises at least one of a general visual inspection of the wing and a non-destructive inspection of portions of the wing.

3. A method according to claim 2 comprising at least one of an eddy current inspection, x-ray inspection, and an ultrasonic scanner.

4. A method according to claim 2 comprising inspecting the wing for advanced dynamic changes and interface inconsistencies over an area.

5. A method according to claim 1 wherein removing at least one existing fasteners from the wing comprises removing fasteners in phases so components of the wing do not move with respect to one another.

6. A method according to claim 1 wherein reworking the fastener holes using a coldworking process comprises:
cleaning the fastener hole;
performing an inspection of the fastener hole; and
reaming the fastener hole to a pre-coldwork diameter.

7. A method according to claim 6 wherein performing an inspection of the fastener hole comprises at least one of an eddy current inspection, an x-ray inspection, and an ultrasonic scan of the fastener hole and an area surrounding the fastener hole.

8. A method according to claim 1 wherein installing oversized fasteners comprises installing an oversize interference fit pin.

9. A method according to claim 1 wherein coldworking the fastener holes using a coldworking process comprises introducing compressive residual stress around the fastener holes.

10. A method according to claim 9 wherein introducing compressive residual stress around the fastener holes comprises:
installing a split sleeve over a mandrel and onto a shaft having nosecap;
inserting the mandrel and shaft through a fastener hole until the nosecap causes the sleeve to engage the fastener hole; and
removing the shaft and mandrel, an engagement between the sleeve and the mandrel causing an expansion of the aircraft wing material around the fastener hole.

11. A method for processing an aircraft structure, said method comprising:
removing at least one existing fastener from the structure;
inducing a compressive field around at least one fastener hole corresponding with the removed fastener using a coldworking process; and
installing a fastener into each coldworked fastener hole.

12. A method according to claim 11 wherein the structure is an aircraft wing attached to an aircraft fuselage.

13. A method according to claim 11 further comprising inspecting the aircraft structure to determine an applicability of the coldworking process.

14. A method according to claim 11 wherein inducing a compressive field around the fastener holes comprises:
installing a split sleeve over a mandrel and onto a shaft having nosecap;
inserting the mandrel and shaft through a fastener hole until the nosecap causes the sleeve to engage the fastener hole; and
removing the shaft and mandrel, an engagement between the sleeve and the mandrel causing a cold expansion of the structure in the area of the fastener hole.

15. A method according to claim 11 further comprising:
performing an eddy current inspection of the fastener hole; and
reaming the fastener hole to a pre-coldwork diameter.

16. A method according to claim 11 wherein installing a fastener into each coldworked fastener hole comprises installing an oversize interference fit pin.

17. A method for reworking a C-130 aircraft wing while attached to an aircraft fuselage to prolong the onset of advanced dynamic changes, said method comprising:
verifying components of the C-130 aircraft wing are in a condition acceptable for reworking;
removing at least one existing fastener from the C-130 aircraft wing;
reworking the at least one fastener hole using a coldworking process; and
installing an oversized fastener into the at least one reworked fastener hole.

18. A method according to claim 17 wherein verifying components of the C-130 aircraft wing are in a condition acceptable for reworking comprises at least one of a general visual inspection of the wing and a non-destructive inspection of portions of the wing.

19. A method according to claim 19 wherein removing at least one existing fasteners from the C-130 aircraft wing comprises removing fasteners in phases so components of the wing do not move with respect to one another.

20. A method according to claim 17 wherein reworking the fastener holes using a coldworking process comprises:
cleaning the fastener hole;
performing an inspection of the fastener hole; and
reaming the fastener hole to a pre-coldwork diameter.

21. A method according to claim 20 wherein performing an inspection of the fastener hole comprises at least one of an eddy current inspection, an x-ray inspection, and an ultrasonic scan of the fastener hole and an area surrounding the fastener hole.

22. A method according to claim 17 wherein coldworking the fastener holes using a coldworking process comprises introducing compressive residual stress around the fastener holes.

23. A method according to claim 22 wherein introducing compressive residual stress around the fastener holes comprises:
installing a split sleeve over a mandrel and onto a shaft having nosecap;
inserting the mandrel and shaft through a fastener hole until the nosecap causes the sleeve to engage the fastener hole; and
removing the shaft and mandrel, an engagement between the sleeve and the mandrel causing an expansion of the aircraft wing material around the fastener hole.

24. A C-130 aircraft wing reworked to induce a compressive field around at least one fastener hole comprising:
a plurality of fastener holes reworked in phases without removing wing structure using a split sleeve coldworking process;
each said fastener hole is reamed to a post-coldwork diameter;
a new countersink size is applied to each said fastener hole; and
an oversized fastener installed in each reworked said fastener hole.
